(19) United States
(12) Patent Application Publication
(10) Pub. No.: US 2018/0069859 A1
(43) Pub. Date: Mar. 8, 2018

(54) MOBILE TERMINAL AND CONTROL METHOD THEREOF

(71) Applicants: Taein KANG, Seoul (KR); Sanghoon LEE, Seoul (KR); Miyoung KWON, Seoul (KR); Hoonkyu KIM, Seoul (KR); Seongkee LEE, Seoul (KR); Kyuho LEE, Gwangmyeong-si (KR)

(72) Inventors: Taein KANG, Seoul (KR); Sanghoon LEE, Seoul (KR); Miyoung KWON, Seoul (KR); Hoonkyu KIM, Seoul (KR); Seongkee LEE, Seoul (KR); Kyuho LEE, Gwangmyeong-si (KR)

(73) Assignee: AGENCY FOR DEFENSE DEVELOPMENT, Daejeon (KR)

(21) Appl. No.: 15/424,177

(22) Filed: Feb. 3, 2017

(30) Foreign Application Priority Data
Sep. 2, 2016 (KR) 10-2016-0113422

(51) Int. Cl. H04L 29/06; H04L 29/08; G06F 17/30

(52) U.S. Cl. CPC H04L 63/10; G06F 17/30864; H04L 67/10

(57) ABSTRACT

A mobile terminal and a method for controlling the mobile terminal are provided. The mobile terminal and the method are capable of controlling access to data shared between different applications. A shared database of the terminal manages multiple shared data, which are generated from different applications. A data service program allows a random application to share one or more of the shared data by accessing the shared database, when a sharing request is received from the random application. A security framework functions to block or transfer the sharing request with respect to the data service program, based on an authority provided to the random application. The mobile terminal can block access to the data service program from a malicious application at the framework level and accept only the access to the data service program from an application which is normally accepted.

### CROSS-REFERENCE TO RELATED APPLICATIONS

Pursuant to 35 U.S.C. §119(a), this application claims the benefit of earlier filing date and right of priority to Korean Application No. 10-2016-0113422, filed on Sep. 2, 2016, the contents of which is incorporated by reference herein in its entirety.

### BACKGROUND OF THE INVENTION

### 1. Field of the Invention

The present invention relates to a mobile terminal having an operating system comprised of a plurality of layers and a control method thereof.

### 2. Background of the Invention

Applications installed in a mobile terminal are respectively allocated with an installation path and/or a storage path, and store data in the allocated paths. Since the applications store data in the allocated paths, the applications cannot share data mutually.

However, in case of data (hereinafter, referred to as ‘shared data’) that may be accessed commonly by various applications such as contact address list, call list, message, and calendar, the various applications may access the shared data in a framework through a data service program. In this respect, it is likely that personal information included in the shared data may be leaked out by a malicious application, etc. Also, since the shared data may be leaked out without any restriction by a malicious attack of rooting and a remote control system (RCS), this causes a social issue.

Although a technique for controlling an access to the shared data at a kernel level of an operating system exists, this technique could perform only a control of a program unit. Therefore, the need of a technique for selectively controlling applications which access shared data through a data service program has been raised.

### SUMMARY OF THE INVENTION

Therefore, an object of the present invention is to substantially obviate one or more problems due to limitations and disadvantages of the related art.

Another object of the present invention is to provide a mobile terminal that may control an access to shared data shared by different applications and a control method thereof.

Other object of the present invention is to provide a mobile terminal that may efficiently control an access to shared data by controlling the access at a kernel level and a framework level of an operating system installed therein, and a control method thereof.

To achieve these and other advantages and in accordance with the purpose of the invention, as embodied and broadly described herein, the present invention relates a mobile terminal having an operating system provided with a plurality of layers and a control method thereof. The mobile terminal comprises shared database configured to manage a plurality of shared data generated from different applications; a data service program configured to allow a random application to share at least one of the shared data by using the shared database if a sharing request for the at least one of the shared data is received from the random application; and a security framework configured to block the sharing request or transfer the sharing request to the data service program on the basis of an authority given to the random application if the sharing request is generated from the random application.

In one embodiment, the mobile terminal may further comprise a security framework database storing a list of applications, which can use the shared database, wherein the security framework may identify the authority given to the random application by using the security framework database.

In one embodiment, each application item included in the list of applications may include an application identifier corresponding to a specific application, and an operation that may be requested by the specific application.

In one embodiment, the operation that may be requested by the specific application may include at least one of generation of new shared data, and query, deletion and update of predetermined shared data.

In one embodiment, the operation that may be requested by each application may be different per application.

In one embodiment, the mobile terminal may further comprise a security kernel configured to block or accept an access to the shared database on the basis of an administrator authority given to a random program if the access to the shared database occurs from the random program to which the administrator authority is given.

In one embodiment, the mobile terminal may further comprise a security kernel database storing a list of programs that can use the shared database, wherein the security kernel identifies the authority given to the random program by using the security kernel database.

In one embodiment, each program item included in the list of programs may include a program identifier corresponding to a specific program, a type of shared data that may be requested by the specific program, and an operation that may be requested by the specific application.

In one embodiment, the operation that may be requested by each program may be different per program.

In one embodiment, the respective programs may have their respective access authorities different from each other for each of the shared data.

In one embodiment, in an operating system that includes a framework level and a kernel level, the security framework may be arranged on the framework level and the security kernel may be arranged on the kernel level.

In one embodiment, the mobile terminal may further comprise a security management program configured to perform update for at least one of the security framework database and the security kernel database.

Meanwhile, a control method of a mobile terminal according to the present invention comprises performing a sharing request for at least of shared data from a random application installed in the mobile terminal; blocking the sharing request or transferring the sharing request to a data service program in a security framework on the basis of an authority given to the random application; sharing the shared data, of which sharing has been requested, with the random application by using a shared database in the data service program if the sharing request is received, wherein the shared database is configured to manage a plurality of shared data generated from different applications.

In one embodiment, the step of blocking the sharing request or transferring the sharing request may include identifying the authority given to the random application in the security framework by using a security framework database; and blocking the sharing request in the security framework or transferring the sharing request from the security framework to the data service program in accordance with the identified result, wherein the security framework database may store a list of applications that can use the shared database.

In one embodiment, the operation of the sharing request, which may be requested by each application, may be different per application.

In one embodiment, the control method of a mobile terminal may further comprise the steps of generating an access to the shared database from a random program to which an administrator authority is given; and blocking or accepting the access in a security kernel on the basis of the authority given to the random program.

In one embodiment, the step of blocking or accepting the access may include identifying the authority given to the random program in the security kernel by using a security kernel database; and blocking or accepting the access in the security kernel in accordance with the identified result, wherein the security kernel database may store a list of programs, which can use the shared database.

In one embodiment, the operation that may be requested by each program may be different per program, and the respective programs may have their respective access authorities different from each other for each of the shared data.

In one embodiment, in an operating system that includes a framework level and a kernel level, the security framework may be arranged on the framework level and the security kernel may be arranged on the kernel level.

In one embodiment, the control method of a mobile terminal may further comprise the step of performing update for at least one of the security framework database and the security kernel database in a security manage program.

The mobile terminal according to the present invention may accept a normal access of the data service program while blocking the access to the shared data from a malicious attack such as rooting by controlling the access to the kernel level at the kernel level of the operating system installed in the mobile terminal.

Moreover, the mobile terminal according to the present invention blocks the access to the data service program from a malicious application at the framework level and accepts only the access to the data service program from an application which is normally accepted.

Therefore, the mobile terminal may efficiently control the access to the shared data from the malicious application and rooting program, and may allow the application, which is normally authorized, to continue to use the shared data through the data service program.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWING

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram illustrating an architecture of an operating system installed in a mobile terminal;

FIG. 2 is a conceptual diagram illustrating a method for accessing shared data in a mobile terminal;

FIG. 3 is a conceptual diagram illustrating a procedure of leaking out shared data due to a malicious application or program;

FIG. 4 is a conceptual diagram illustrating a procedure of controlling an access to shared data through a security framework and a security kernel;

FIG. 5 is a flow chart illustrating a control method of a mobile terminal according to one embodiment of the present invention;

FIG. 6 is an exemplary view illustrating a structure of a security framework database according to one embodiment of the present invention; and

FIG. 7 is an exemplary view illustrating a structure of a security kernel database according to one embodiment of the present invention.

### DETAILED DESCRIPTION OF THE PREFERRED EMBODIMENT

Description will now be given in detail of the exemplary embodiments, with reference to the accompanying drawings. For the sake of brief description with reference to the drawings, the same or equivalent components will be provided with the same reference numbers, and description thereof will not be repeated. It is to be understood that the singular expression used in this specification includes the plural expression unless defined differently on the context.

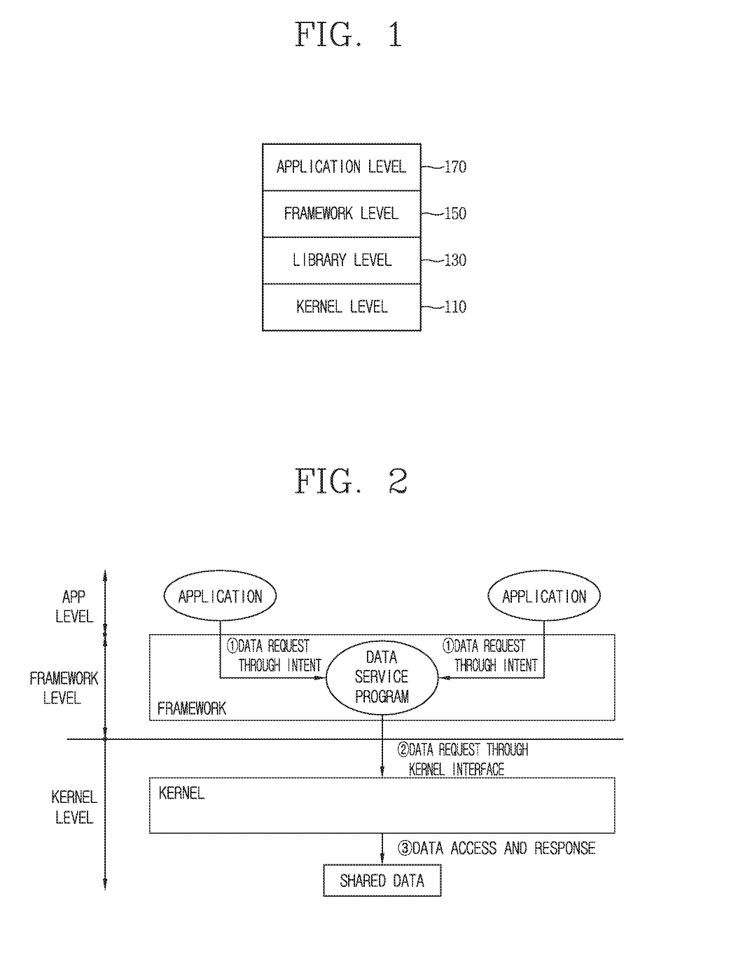

FIG. 1 is a block diagram illustrating an architecture of an operating system installed in a mobile terminal.

The mobile terminal is a hierarchical device comprised of a hardware layer of an integrated circuit (IC) chip level corresponding to the lowest layer, a firmware and operating system (OS) layer corresponding to a layer on the lowest layer, and an application program layer corresponding to the highest layer.

The operating system includes a plurality of levels (or layers), and the levels of the operating system may be referred to as platform or architecture. Moreover, the operating system may include an application program layer (or application level), and serves as a relay for connecting hardware with the application program.

The operating system may be defined as ‘execution manager’ which is a part of a computer system that manages every hardware and every software. Since the operating system manages who can use the computer system and how to use the computer system, the operating system may be referred to as a boss that manages the computer system.

The operating system defines a series of task orders and commands a CPU to execute a program and a special mission, such as file access, application program driving, monitor and memory device control, and keyboard command interpretation, as a series of complicated commands for allocating a series of task orders to various hardware systems such as CPU, main memory and peripheral devices. Also, when several users perform tasks at the same time, the operating system defines a priority of tasks in a time-sharing mode to efficiently distribute time and resource, and controls mutual action with another computer on a network.

In short, the operating system may be referred to as software that controls hardware, manages computer resources, facilitates computer use, assists execution of application programs, and serves as a medium between a user and hardware.

Referring to FIG. 1, an operating system of a mobile terminal 100 includes a kernel level 110, a library level 130, a framework level 150, and an application level 170. The library level 130, the framework level 150 and the application level 170 are sequentially deposited based on the kernel level 110.

The kernel level 110 is arranged on the lowest end.

The kernel level 110 includes a kernel, and provides various basic services to other all parts of the operating system as the most important key point of the operating system.

Generally, the kernel level 110 includes an interrupt processor for processing all requests that contentionally require services of a kernel, such as ended input and output operation, a scheduler for determining which programs will share a processing time of the kernel in what order, and a supervisor for actually giving a use authority of the mobile terminal to each processor if a schedule ends.

Also, the kernel level 110 manages address spaces of the operating system within a memory or a storage device, and has a memory manager that shares the address spaces to all peripheral devices and other users who use services of the kernel level 110. The services of the kernel level 110 are requested through a series of program interfaces known as system call.

In addition, the kernel level 110 may include a power management function optimized for a mobile terminal or a function that controls communication between processors.

The library level 130 is arranged on the kernel level 110.

The library level 130 includes a group of sub-routines and a standardized program used by a user in accordance with the need to seek efficiency in use of the mobile terminal 100. OPEN GL for 3D graphic, SQLLite database that provides a local database, WebKit for web browsing, and media frameworks for multimedia play may be included in the library level 130.

The framework level 150 is arranged on the library level 130, and may be referred to as “application framework level”.

The framework level 150 means a software environment that enables design and implementation of detailed functions to be implemented by a program such as software, application or solution, so as to allow a developer to easily develop the program. The framework level 150 provides a user interface that allows detailed functions, which will be implemented by the program, to be combined in various forms and to be reused.

A framework is included in the framework level 150. In computer programming, the framework may mean a platform that allows a structurally fixed function to be reused and allows a new function, which is not fixed, to be selectively implemented by a code drafted by a user. That is, the framework may be regarded as a semi-product software module that provides a series of cooperative type classes to allow design and implementation corresponding to a standard part essential for development of software to be reused. The software framework includes various different components that enable development of projects or solutions such as support program, compiler, code library, tool set, and API (application programming interface).

If a developer performs development by using the framework, the developer reuses the structure provided by the framework level 150 as it is and additionally implements a function which is not provided, whereby applications may be constructed quickly. Also, since applications that use the same framework have similar frame structures, it is easy to manage and test the applications.

The framework is similar to a library in that it structuralizes a code in a reusable form through an API which is explicitly defined. However, the library cannot designate a control structure of a whole program at a call side, whereas the framework enables inversion of control. Also, unlike the library, the framework may allow a user to reuse a code by specializing the code as a user code that performs selective overriding (redefinition of inherited function) or a specific function.

The framework is intended to allow programmers to reduce the time required to develop common parts except details of applications and concentrate on implementation of detailed requirements.

The framework level 150 may include a package manager, a window manager, a view manager, a resource manager, an activity manager, a contents provider, a location manager, and a notification manager.

The package manager manages applications installed in the mobile terminal 100.

The window manager manages a window screen. In this case, the window means an area that identifies information displayed on a display of the mobile terminal 100.

The view manager manages a basic graphic component.

The resource manager manages a resource which is not compiled. For example, the resource manager manages image files packaged with the application.

The activity manager manages activity of the operating system. This activity corresponds to one screen generated by an application, and the activity manager manages a life cycle from generation to extinction of the activity.

The contents provider is an abstracted layer for a data storage space, which stores data through the contents provider, shares a storage space managed by the contents provider to applications, and may share data between applications by using the storage space.

The location manager provides a location related service function.

The notification manager manages an event which occurs, and provides a function for notifying a user of occurrence of the event.

Meanwhile, the application level 170 is arranged on the framework level 150.

Applications such as contact address, messenger, browser, and camera may be arranged on the application level 170. In this case, the applications mean a set of a series of programs devised to perform a specific function, and may be referred to as an application program. The application level may be referred to as an application program layer.

Although the architecture of the operating system installed in the mobile terminal has been described as above, a method for allowing an application and/or program to access shared data in the architecture of the operating system and a method for leaking out the shared data will hereinafter be described in detail.

FIG. 2 is a conceptual diagram illustrating a method for accessing shared data in a mobile terminal.

Referring to FIG. 2, one or more applications arranged on the application level 170 request access to shared data to use the shared data. In more detail, at least one application requests a data service program of shared data through an API (application programming interface) provided by the framework level 150. This access request (or sharing request) may be performed through an intent.

If the sharing request for the shared data is received, the data service program requests an access to the shared data through an interface provided by the kernel level 110, and the kernel reads the shared data and transfers the read data to the data service program. The data service program transfers the received shared data to the application, which has performed the sharing request, through the API.

In this case, the shared data mean data that may be accessed commonly by various applications arranged on the application level 170. For example, contact addresses stored in an address book, call record, transmitted and received messages and mails, schedules associated with calendar, photos, audios, and videos may be included in the shared data.

The shared data are stored in a predetermined database (DB) (hereinafter, referred to as ‘shared database’). A random application should use the data service program provided by the framework level 150 to access the shared data.

The data service program means an interface used by an application to acquire the shared data. The data service program is arranged on the framework level 150, and has the authority capable of accessing the shared data stored in the database.

The application cannot directly access the shared data, and may acquire the shared data by only using the data service program.

For example, in android, the data service program corresponds to a content provider.

The content provider is one of four components provided in android, and provides an interface scheduled to allow an application to access shared data.

The content provider provides a “passage” to allow another application to use a database within one application, and may define a range of another application, which is capable of accessing the database, whereby a specific item may only be shared.

An interface that inserts, queries, updates, and deletes the shared data is provided by the content provider, and an application may freely access the shared data through the content provider. That is, the access to the shared data is a concept that includes generation of new shared data, and query, update and deletion of the existing shared data.

Each of the shared data is referred to a record, and is stored in the database and then managed by the database. Each of the shared data may be managed by a uniform resource identifier (URI).

Meanwhile, a type of the data service program may be varied depending on a type of the shared data. For example, in case of image, video and audio in android, an access may be performed by a mediastore included in the content provider. For another example, in case of a schedule associated with a calendar in android, an access may be performed by a calendar contract included in the content provider. That is, the operating system of the mobile terminal provides various data service programs, and the data service program, which will be used by the application, is varied depending on a type of data which will be shared.

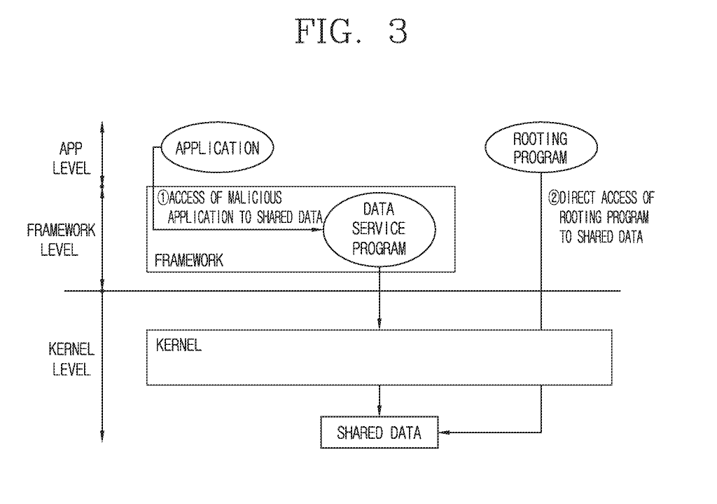

FIG. 3 is a conceptual diagram illustrating a procedure of leaking out shared data due to a malicious application or program.

For example, shared data may be leaked out by a malicious application.

If the malicious application is installed in the mobile terminal, the malicious application may acquire shared data through the data service program. In more detail, the malicious application requests the data service program of shared data like a general application. The data service program transfers the shared data to the malicious application in response to the request of the malicious application.

As a result, the malicious application may acquire the shared data and may also correct/delete/update the shared data maliciously. Also, the malicious application may leak out the shared data acquired through the data service program to the outside through a wireless communication unit of the mobile terminal.

For another example, the shared data may be leaked out by a malicious program that has acquired the administrator authority.

The malicious program may be a rooting program. Rooting means that the mobile terminal loaded with android acquires the administrator authority. In a Linux environment on which an android operating system is based, a user having the authority capable of accessing all files and programs is called a superuser. The superuser uses an account called root. This is similar to an administrator account of the operating system, and corresponds to an account of the best authority having a full authority of the system. Rooting which is commonly mentioned means that this root account is acquired.

Since the malicious program may have a full authority within the mobile terminal due to hacking, a problem may occur in that the malicious program may access the shared data without any restriction by requesting the kernel or the shared database of the shared data.

A problem occurs in that the malicious application acquires the shared data through the data service program and the malicious program acquires the shared data based on the acquired authority.

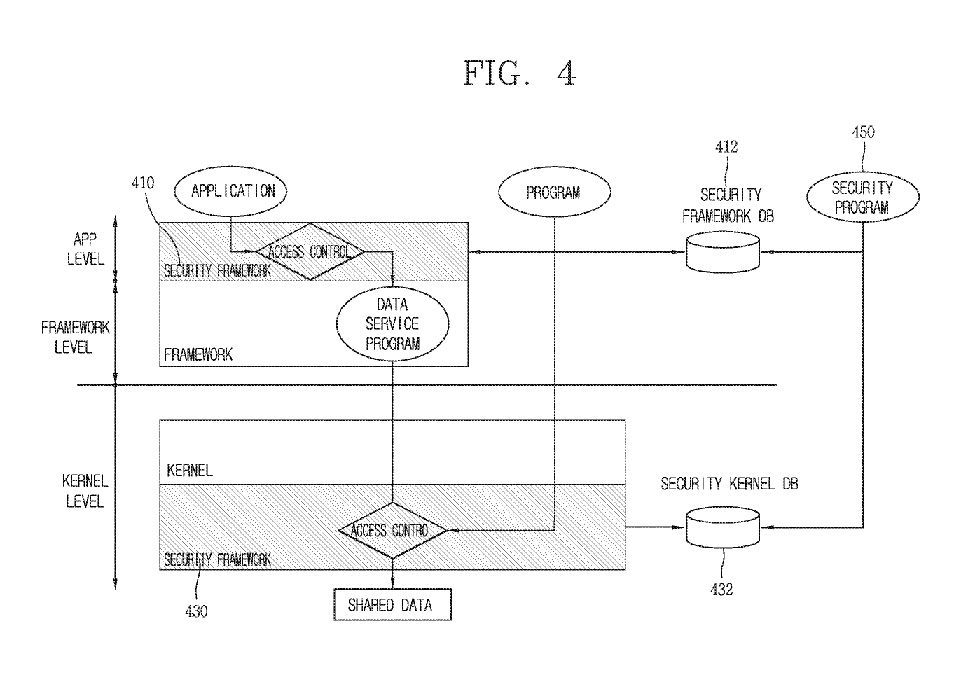

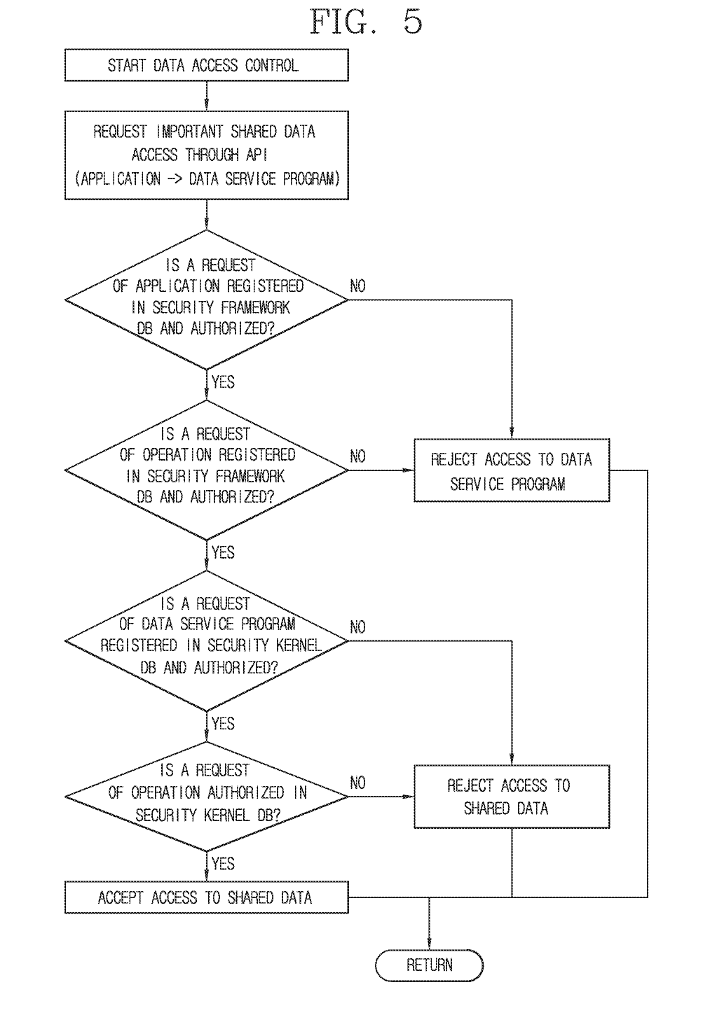

The present invention suggests a method for transplanting at least one of the security framework and the security kernel to the operating system of the mobile terminal to prevent shared data from being leaked out without any restriction. Hereinafter, a mobile terminal and a control method thereof according to the present invention will be described in more detail with reference to FIGS. 4 to 7.

FIG. 4 is a conceptual diagram illustrating a procedure of controlling an access to shared data through a security framework 410 and a security kernel 430.

The security framework 410 is arranged between the application level 170 and the framework level 150. The security framework 410 selectively accepts or blocks a sharing request of the shared data from an application. If the sharing request is accepted, the sharing request is transferred to the data service program through the security framework 410.

As a reference for determining whether the sharing request is accepted, a security framework database 412 is provided. The security framework 410 accepts or blocks the sharing request from the application on the basis of the security framework database 412.

The security kernel 430 is arranged on the kernel level 110. The security kernel 430 selectively accepts or blocks an access of a program having an administrator authority to shared data and/or shared database.

As a reference for determining whether the access is accepted, a security kernel database 432 is provided. The security kernel 430 accepts or blocks the access of the program on the basis of the security kernel database 432.

Meanwhile, the mobile terminal 100 may be provided with a security management program 450. The security management program 450 is configured to perform update for at least one of the security framework database 412 and the security kernel database 432.

In more detail, the security management program 450 may manage shared data corresponding to a protection target.

The security management program 450 may newly generate, update and/or delete a data service program accessing each shared data, an application capable of accessing each data service program, and an operation that may be requested from each application, in respect of the security framework database 412.

Moreover, the security management program 450 may newly generate, update and/or delete shared data to be protected, a program capable of accessing each shared data, and an operation that may be requested from each application, in respect of the security kernel database 432.

Only a system operator who has passed strong authentication such as electronic signature authentication may generate, update and manage the security authority by using the security management program 450.

At least one of the security framework database 412 and the security kernel database 432 is stored in a safe storage space controlled by the security kernel 430, and may be arranged in a physically detached space that cannot be accessed even by a root account. For example, at least one of the security framework database 412 and the security kernel database 432 is stored below a specific directory like a general file or database, wherein a location of the directory may be shielded so as not to be discovered by a user (that is, so as not to be searched). For another example, at least one of the security framework database 412 and the security kernel database 432 may be stored in an independent space in hardware (for example, trust zone of ARM chip).

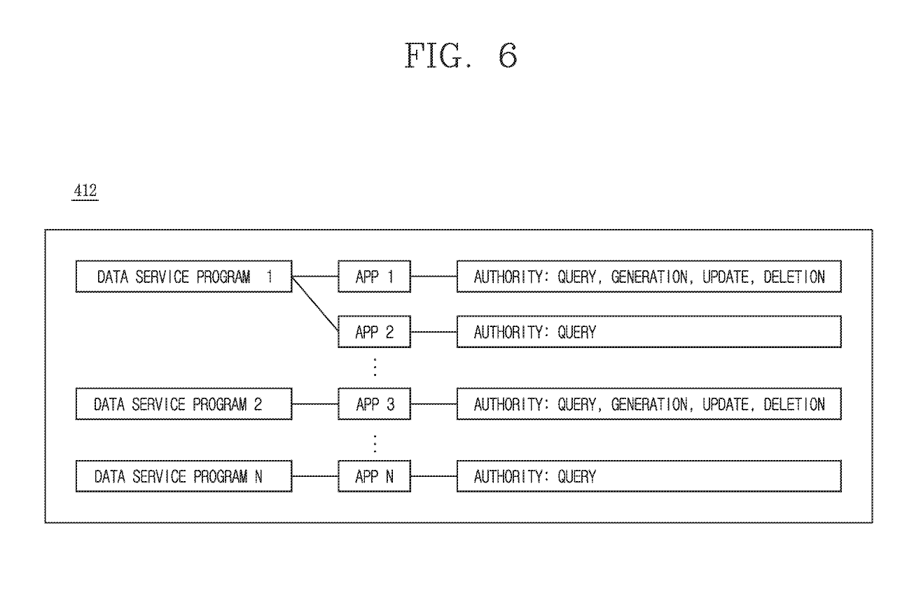

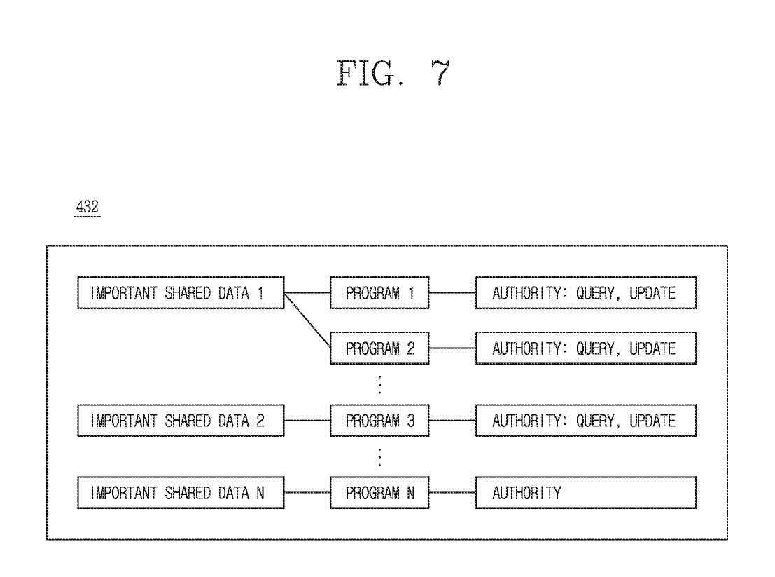

FIG. 5 is a flow chart illustrating a control method of a mobile terminal according to one embodiment of the present invention, FIG. 6 is an exemplary view illustrating a structure of a security framework database according to one embodiment of the present invention, and FIG. 7 is an exemplary view illustrating a structure of a security kernel database according to one embodiment of the present invention.

First of all, access control for shared data starts.

For access control, at least one of the security framework 410 and the security kernel 430 is transplanted to the operating system of the mobile terminal. The security framework 410 is installed in the framework level 150, and the security kernel 430 is installed in the kernel level 110. That is, in the operating system that includes the framework level 410 and the kernel level 110, the security framework 410 may be arranged on the framework level 150, and the security kernel 450 may be arranged on the kernel level 110.

Next, an access request for the shared data may be received.

For example, a random application installed in the mobile terminal may perform a sharing request for at least one of the shared data, or a random program having the administrator authority may perform the access to the shared data.

If a random application performs a sharing request, the sharing request may be performed through the API, and is basically blocked by the security framework 410.

The security framework 410 blocks the sharing request on the basis of the authority given to the application, which has performed the sharing request, or transfers the sharing request to the data service program.

If the sharing request is transferred to the data service program, the data service program shares the shared data of which sharing has been requested in the application by using a shared database. In this case, the shared database means a set of shared data, which manages shared data generated from different applications.

The security framework database 412 is provided to allow the security framework 410 to identify the authority given to the application. The security framework 410 identifies the authority given to the application, which has performed the sharing request, by using the security framework database 412.

Referring to FIG. 6, the security framework database 412 stores and manages a list of applications, which may use the shared database.

Each application item included in the list of applications may include an application identifier corresponding to a specific application and an operation that may be requested from the specific application.

The operation that may be requested from the specific application may include at least one of generation of new shared data, and query, deletion and update of previously stored shared data. Since different applications per application, that is, an operation that may be requested is given separately, an operation that may be requested from each application is varied per application.

For example, although an application 1 may perform query, generation, update and deletion by using a data service program 1, an application 2 may perform only query by using the data service program 1. For another example, since the application 1 does not have the authority for a data service program 2, if a sharing request of the application 1 uses the data service program 2, the corresponding sharing request is blocked.

Referring to FIG. 5 again, the security framework 410 identifies whether the sharing request is registered in the security framework database and is a request from an authorized application, and identifies whether the sharing request is an authorized operation request. If the sharing request is the request of an application which is not authorized or an operation which is not authorized, the access to the data service program is rejected.

In other words, the sharing request sent from the application to the data service program is controlled by the security framework 410. The sharing request for the data service program is basically blocked, and the sharing request for only the application which is registered and authorized may be sent to the data service program. The security framework 410 identifies whether there is the application registered and authorized by the security framework database 412 and the operation that may be requested, and controls the corresponding application and operation.

Next, if a random program accesses the shared data, this access is basically blocked by the security kernel 430. In more detail, if an access to the shared database occurs from a random program to which the administrator authority is given, the security kernel 430 blocks or accepts the access on the basis of the authority given to the random program.

Specifically, the mobile terminal is provided with a security kernel database 432 for storing a list of programs that can use the shared database, and the security kernel 430 identifies the authority given to the program accessing the shared database by using the security kernel database 432.

Referring to FIG. 7, the security kernel database 432 stores and manages the list of programs that can use the shared database.

Each program item included in the list of programs may include a program identifier corresponding to a specific program, a type of shared data that may be requested by the specific program, and an operation that may be requested by the specific program.

The operation that may be requested by each program may be set differently per program. The respective programs may have their respective access authorities different from each other for each of the shared data.

For example, although a program 1 and a program 2 have the authority for shared data 1, the program 1 can perform query, update or deletion of shared data, and the program 2 can perform query/update of the shared data. That is, the program 2 cannot delete shared data 2. For another example, only a program 3 may have the authority for shared data 3, and may perform query/update of the shared data 2.

Since an access authority may be set differently for each of the shared data, the shared data may be managed differently depending on a security level.

Programs are controlled to access important shared data. An access of all programs to important shared data is basically blocked, and only a program which is registered and authorized may access the important shared data. And, the security kernel identifies whether there is a program registered by a security kernel control policy DB and an operation that may be accessed, and controls the program and the operation.

Referring to FIG. 5 again, if an access of a program to the shared database occurs, the security kernel 430 identifies whether the sharing request is registered in the security kernel database and is a request from an authorized program, and identifies whether the sharing request is an authorized operation request. If the sharing request is the request of an application which is not authorized or an operation which is not authorized, the access to the data service program is rejected.

In other words, the access of at least one program to the shared data is controlled by the security kernel 430. The access of all programs to the shared data is basically blocked, and only a program which is registered and authorized may access the shared data. The security kernel 430 identifies whether the corresponding program is registered by the security kernel database and the corresponding operation that may be accessed, and controls the corresponding program and operation.

According to the present invention, since access control for the shared data essentially required for the mobile terminal can be implemented efficiently, security and efficiency for the shared data can be enhanced.

Particularly, in the present invention, an android operating system is applied to the mobile terminal. Also, the present invention is devised through comprehensive understanding for high-level hacking and information protection technology, a framework of android and a kernel below the framework. The present invention suggests a method for strengthening the weak point (hacking through application or hacking through rooting attack of high level), which may occur due to a characteristic (access to shared data may be performed using a unique process such as a data service program provided by the operating system, instead of an entity which desires to access shared data) of the android system, at an android framework level and a kernel level by understanding the characteristic of the android system.

If the mobile terminal according to the present invention is used in a military organization, strategy information and confidential information may be used as shared data and at the same time an access to the information may be controlled efficiently. Therefore, it is advantageous that troops related to strategy management and protection of shared data may be minimized.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

1. A mobile terminal comprising:
a shared database configured to manage a plurality of shared data generated from different applications;
at least one data service program configured to allow a random application to share at least one of the shared data by using the shared database when a sharing request for the at least one of the shared data is received from the random application; and
a security framework configured to block the sharing request or transfer the sharing request to the data service program on the basis of an authority given to the random application when the sharing request is generated from the random application,
wherein the at least one data service program comprises a plurality of data service programs,
wherein one of the plurality of data service programs is a data service program for sending the sharing request by the random application, and said one of the plurality of data service programs is variable in response to a type of the shared data,
wherein, when a right of the random application is set differently according to each service data program, sharing a predetermined type of the shared data with the random application is prevented by the right of the random application, and
wherein the type of shared data comprises at least one of photos, videos, audios, schedules associated with calendar, messages, mails, call record and contacts.

2. The mobile terminal according to claim 1, further comprising a security framework database storing a list of applications, which can use the shared database, wherein the security framework identifies the authority given to the random application by using the security framework database.

3. The mobile terminal according to claim 2, wherein each application item included in the list of applications includes an application identifier corresponding to a specific application, and an operation that may be requested by the specific application.

4. The mobile terminal according to claim 3, wherein the operation that may be requested by the specific application includes at least one of generation of new shared data, and query, deletion and update of predetermined shared data.

5. The mobile terminal according to claim 4, wherein the operation that may be requested by each application is different per application.

6. The mobile terminal according to any one of claims 1 to 5, further comprising a security kernel configured to block or accept an access to the shared database on the basis of an administrator authority given to a random program if the access to the shared database occurs from the random program to which the administrator authority is given.

7. The mobile terminal according to claim 6, further comprising a security kernel database storing a list of programs that can use the shared database, wherein the security kernel identifies the authority given to the random program by using the security kernel database.

8. The mobile terminal according to claim 7, wherein each program item included in the list of programs includes a program identifier corresponding to a specific program, a type of shared data that may be requested by the specific program, and an operation that may be requested by the specific application.

9. The mobile terminal according to claim 8, wherein the operation that may be requested by each program is different per program.

10. The mobile terminal according to claim 8, wherein the respective programs have their respective access authorities different from each other for each of the shared data.

11. The mobile terminal according to claim 6, wherein, in an operating system that includes a framework level and a kernel level, the security framework is arranged on the framework level and the security kernel is arranged on the kernel level.

12. The mobile terminal according to claim 6, further comprising a security management program configured to perform update for at least one of the security framework database and the security kernel database.

13-20. (canceled)
